(19) United States
(12) Patent Application Publication
(10) Pub. No.: US 2026/0194380 A1
(43) Pub. Date: Jul. 9, 2026

(54) SUGARCANE HARVESTER ELEVATOR MASS FLOW SENSOR

(71) Applicant: Topcon Positioning Systems, Inc., Livermore, CA (US)

(72) Inventors: James SCHNAIDER, Saskatoon (CA); Matthew PETRYSHYN, Hague (CA); Jeff CUNNINGHAM, Saskatoon (CA)

(73) Assignee: Topcon Positioning Systems, Inc., Livermore, CA (US)

(21) Appl. No.: 19/443,092

(22) Filed: Jan. 8, 2026

Related U.S. Application Data
(60) Provisional application No. 63/743,392, filed on Jan. 9, 2025.

(51) Int. Cl. G01F 1/76; A01D 41/127

(52) U.S. Cl. CPC G01F 1/76; A01D 41/1271

(57) ABSTRACT

A method for determining a mass flow of harvested material moving through a material elevator and a sugarcane harvester elevator mass flow sensor.

### CROSS-REFERENCE TO RELATED APPLICATIONS

This application claims the benefit under 35 U.S.C. 119(e) of prior-filed U.S. Provisional Patent Application No. 63/743,392, filed Jan. 9, 2025; the disclosure of which is incorporated herein by reference in its entirety.

### FIELD OF THE INVENTION

The present disclosure relates generally to crop harvesting, and more particularly to a sugarcane harvester elevator mass flow sensor.

### BACKGROUND

Sugarcane yield monitors typically estimate mass throughput by indirect measurement methods, such as processing power consumption or volumetric throughput. As conditions change (for example specific processing power requirements or material density) errors in the estimation of mass will occur, requiring recalibration. These systems are typically calibrated by matching the yield monitor estimated accumulated mass to a measurement of true mass as weighed by a scale. Cane carts with built-in weighing scales are relatively uncommon due to the added complexity and cost of instrumentation. What is needed is a method for direct measurement of mass flow on sugarcane harvesters.

### SUMMARY

A method for determining a mass flow of harvested material moving through a material elevator includes the steps of receiving load data from a force sensor (e.g., a loadcell) mounted to a slat of the material elevator, receiving data from an inertial measurement unit (IMU) pertaining to an angle of the slat, and determining a mass flow of material conveyed by the material elevator based on the load data and the data from the inertial measurement unit. The IMU can be located on a slat, a frame of the material elevator, or both. A first IMU can be located on the slat and a second IMU can be mounted to a frame of the material elevator. The first IMU can measure movement of the slat and the second IMU can measure an angle between a direction of the movement of the slat and horizontal. The method can also include the steps of determining a coefficient of friction based on the load data and the data from the IM, determining a force associated with the slat as it is conveying material, determining a weight of material conveyed by the slat based on the coefficient of friction and the force associated with the slat, and determining a speed of the material elevator based on the data from the IMU. The method can also include determining a coefficient of friction is based on the load data measured at a plurality of points of the slat travel. The method can also include correcting a signal from the force sensor of the slat measured on a loaded side of the elevator based on a change in amplitude from the force sensor of an unloaded slat on an unloaded side of the elevator.

An apparatus and computer readable medium for determining a mass flow of harvested material moving through a material elevator are also described herein.

### BRIEF DESCRIPTION OF THE DRAWINGS

FIG. 1 shows a sugarcane harvester harvesting sugarcane from a field;

FIG. 2 shows an elevator of a sugarcane harvester according to one embodiment;

FIG. 3 shows a slat located on an upper side of an elevator according to one embodiment;

FIG. 4 shows a force sensor and slat module attached to the slat of FIG. 3 according to one embodiment;

FIG. 5 shows a force sensor, slat module, and an IM attached to the slat of FIG. 3 according to one embodiment;

FIG. 6 shows an elevator of the sugarcane harvester shown in FIG. 1 according to one embodiment;

FIG. 7 shows the path slats of an elevator travel according to one embodiment;

FIG. 8 shows a graph of data output from the force sensor mounted to the slat; and

FIG. 9 shows a high-level diagram of a computer for implementing the methods, devices, techniques, and/or algorithms described herein according to one embodiment.

### DETAILED DESCRIPTION

A sugarcane harvester mass flow sensor and method for continuous mass flow measurement are described herein. The method may function independently or as part of an indirect-measurement mass flow yield monitor, providing a corrective signal for continuous calibration adjustments. Sugarcane harvesters transport harvested material up an elevator before unloading material into carts. After material is cut and processed it is moved up a smooth perforated floor of the elevator by chain-driven slats.

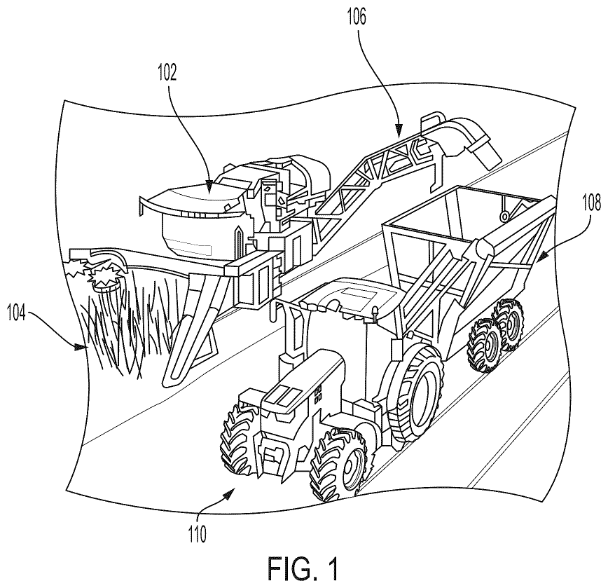

FIG. 1 shows a sugarcane harvester 102 shown harvesting sugarcane from sugarcane field 104. Harvested sugarcane material is transported by elevator 106 into material cart 108. Cart 108 can be moved by tractor 110.

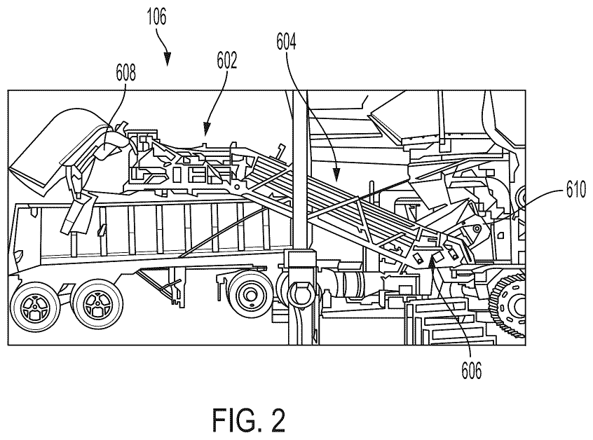

FIG. 2 shows a side view of elevator 106 having an upper section 602, center section 604, and lower section 606. Slats are located in elevator 106 and travel in a chain driven loop. A slat travels from upper surface of lower section 606 and then along upper surface of center section 604. The slat then travels to upper surface of upper section 602 before it is turned at upper end 608 by an end sprocket (not shown) causing the slat to travel from the upper surface of upper section 602 to the lower surface of upper section 602. The slat then travels along the lower surface of center section 604 to lower section 606. At lower section 606, slat is turned at low end 610 by an end sprocket (not shown) so that it travels from the lower surface of lower section 606 to the upper surface of lower section 606.

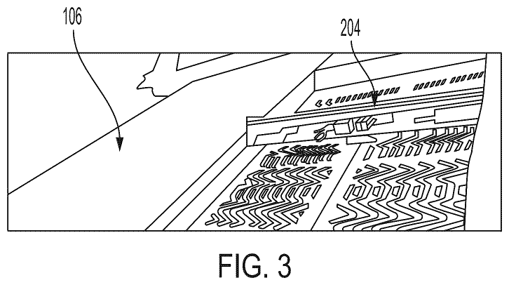

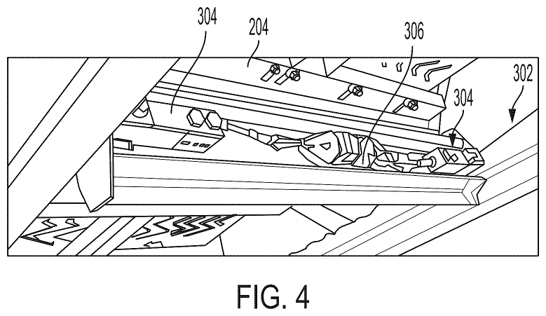

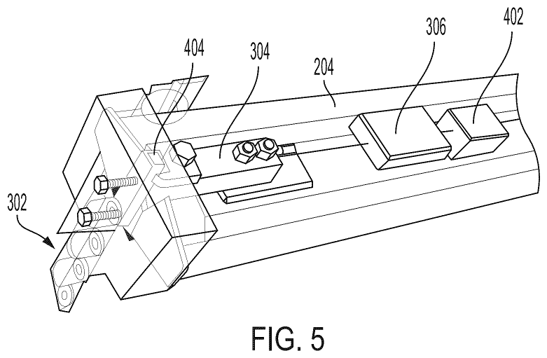

FIG. 3 shows slat 204 located on upper surface of center section 604 of elevator 106. FIG. 4 shows slat 204 travelling along lower surface of center section 604. FIG. 4 also shows components attached to slat 204 including slat module 306. Slat module can be a wireless battery-powered module that processes data from force sensors 304 (e.g., loadcells or other sensor for measuring force). Slat module also processes data from IM 402 (shown in FIG. 5) and communicates signals wirelessly to a receiver (not shown).

FIG. 5 shows force sensors 304 attached to chains 302 via bracket 404. Slat module 306 is in communication with force sensors 304. Slat module 306 is also in communication with inertial measurement unit (IM) 402. In one embodiment, slat module 306 is a wireless battery-powered module that receives (and may also process) data from force sensors 304 and IM 402 and communicates signals wirelessly to a receiver.

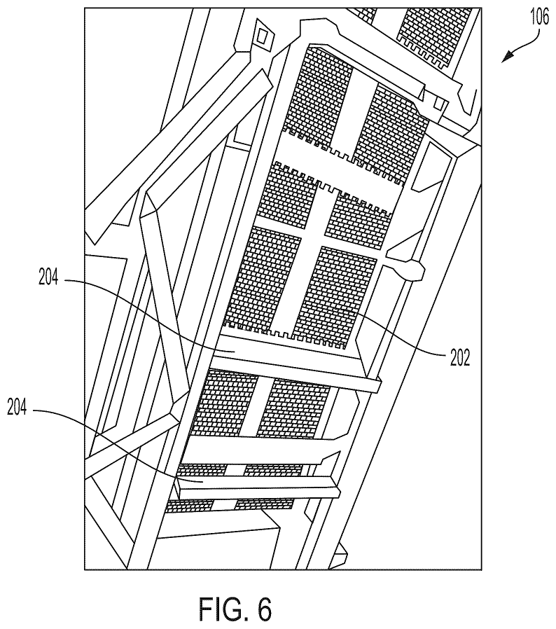

FIG. 6 shows elevator 106 which moves harvested material over smooth perforated floor 202 by slats 204. In one embodiment, elevator 106 has a plurality of slats 204 which are connected to and driven by chains located on opposite ends of each of the plurality of slats 204. Each of the plurality of slats is attached to chains which move the plurality of slats 204 in a manner to convey material from one end of elevator 106 to an opposite end of elevator 106.

Each of slats 204 is supported on each side by chains 302 and typically only makes contact with the harvested material as it is pushed up the inclined floor. Installing force sensors between the chain mounting points and the slat provides a signal indicative of the force applied by the chain to convey the material, and the resulting force from the weight of the slat. The force sensors measure force applied normal to the face of the slat, but measurement in other directions is possible.

As described above, the slats travel around the path (i.e., loop) of elevator 106, pushing material up the inclined floor and then returning on the bottom-side of the elevator, unloaded. As the material is being pushed up the floor a signal is produced based on the force due to the weight of the material, the weight of the slat, and the force due to friction which is based on the kinetic friction of the material sliding across the smooth floor and the weight of the material. On the return path (i.e., the underside of elevator 106) the slat is inverted vertically and is not moving any material, but the weight of the slat is still measured, although now the signal is inverted.

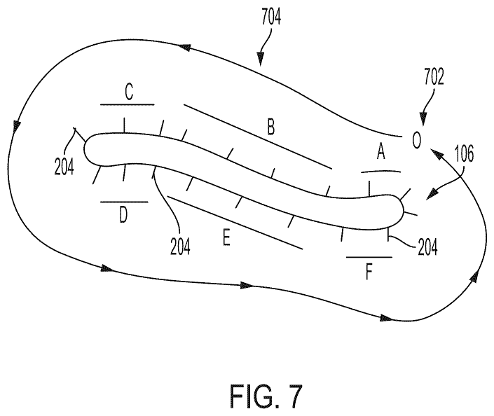

Common elevators feature three sections of different inclinations producing six distinct regions and two end-points where the slat goes over the end sprockets (three regions on the upper surface and three complimentary regions on the lower surface). FIG. 7 shows a simplified schematic depicting how slats 204 travel along elevator 106. A slat staring at origin “o” 702 travels path 704 shown in FIG. 7 counterclockwise around an elevator. Each slat travels along the elevator traversing sections A-F. As shown in FIG. 7, sections A and F have the same incline, sections B and E have the same incline and sections C and D have the same incline. Each of the sets of inclines are considered complimentary.

In one embodiment, IMU 402 (shown in FIG. 4) comprises at least one gyroscope and at least one accelerometer. However, IMU 402 can have more gyroscopes and accelerometers. For example, IMU 402 can have at least 3 gyroscopes and 3 accelerometers, with one gyroscope and accelerometer used for each axis (e.g., x, y, and z axes). In one embodiment, IMU 402 is used to determine the position of a slat to which it is attached at any point based on angle measurements, rate of angle change, measured elevator RPM, and time. In one embodiment, the 180 degree turns at each end of the elevator are measured as well as the orientation (up vs down) to determine one end of elevator 106 from the other. In one embodiment, this information is used by slat module 306 to set (e.g., define) an elevator origin as the base of the elevator (at origin “o” 702 shown in FIG. 7) and, after a stable RPM has been measured based on the data collected, slat module 306 estimates its position (and the position of the slat to which it is attached) through the motion of the elevator based on RPM (e.g., a recent RPM average) and elapsed time. Slat module 306 can then sample data for each section of the elevator. Methods other than the method described above can be used to determine the position of a slat/slat module as well. For example, elevator speed can be measured based on a speed of a shaft driving the elevator and the positioning of a slat can be detected using a proximity sensor to detect a slat (e.g., the slat having sensors, such as a force sensor and/or an IMU) as it passes a known location.

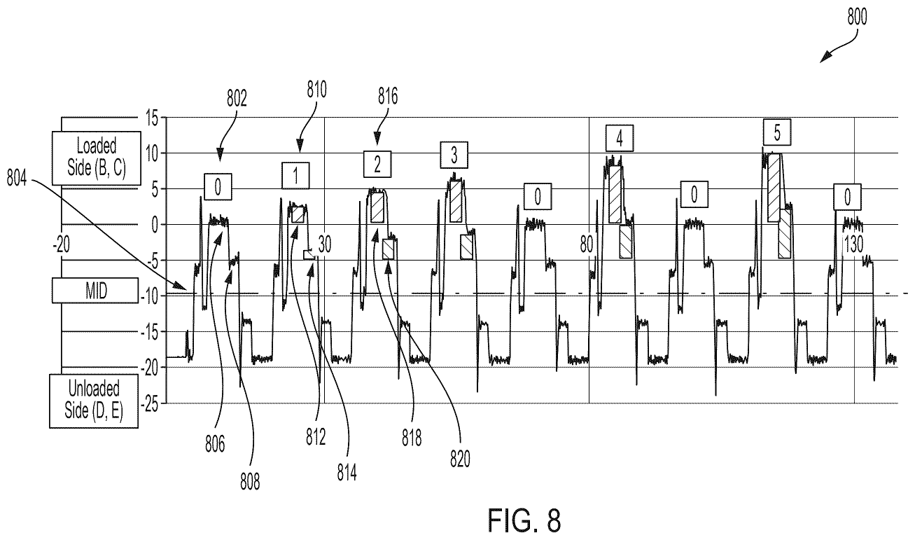

When the elevator is running empty (zero-throughput) the system can establish a midpoint and amplitude for the force signal, as shown at 802 in graph 800 of FIG. 8 (“0” units of throughput). The midpoint of the signal is shown as “MID” at 804 in FIG. 8. For each complimentary pair of signals (signals output by load sensors as slat travels along sections B and E, and along sections C and D) the signal is mirrored about the midpoint. The amplitude at this point is based on the weight of the unloaded slat. The midpoint of each complimentary pair is theoretically the same value because for each complimentary set of measurements the signal produced by the weight of the slat inverts as its orientation inverts 180 degrees. If the elevator was constructed in a way does not invert the slat exactly 180 degrees, the signal may be compensated by angle measurements.

At each section of the elevator the inclination angle is also measured (measured by IMU 402 on a slat, or by other methods). Note the change in inclination is constant (based on shape of elevator).

When running at zero-throughput the system is able to detect the amplitude for each complimentary section. This condition is shown at 806 and 808, where no material (0 units) is transported by the elevator. This information can be captured and stored in a memory of slat module 306.

As material is introduced the force measured by the slat on the loaded side will increase over the zero-throughput value, as shown at 810 in graph 800 of FIG. 8 where one unit of material is being transported. This increase in force, as shown by the cross-hatched squares 812 and 814 will be measured in section B and C (shown in FIG. 7). This additional force, on top of the baseline force, is the force due to the weight of the material, plus the force due to friction. No signal change will occur to the signals measured on the unloaded side of the elevator (section D and E) due to material transport. As larger loads are transported by the elevator, the signal will further increase over the baseline load. For instance, as two units of material are transported, as shown at 816, the measures loads increase further as shown by cross-hatched squares 818 and 820.

It is likely that mud and/or debris will collect on the slat, increasing its weight and potentially leading to signal errors by modifying the force in the measurement section B and C. Mud and/or buildup does not affect the midpoint value but it does affect the apparent weight of the slat represented by the amplitude. By running the elevator empty (zero-throughput) a new amplitude value for the unloaded system may be detected. However, this buildup can also be detected by measuring the change of the signals measured in section D and E, with no need to re-zero the system. The midpoint will not change but the baseline or zero-throughput amplitude will change. The change in signal due to mud or debris buildup can be detected as the amplitude change measured at sections D and/or E, which can be measured at run-time (as material is being conveyed in sections C and D). Furthermore, as the slat passes through section D and E the weight of the slat can be calculated from the change in force measured as the slat changes angle, and using this information the midpoint for each complimentary pair may also be solved. Therefore, this method provides the advantage of detecting the change in amplitude for each complimentary pair while material is being conveyed, providing constant signal re-taring.

After the signals are processed using these methods, the results are used to solve for the coefficient of kinetic friction. Assuming kinetic friction coefficient is the same for section B and C, the kinetic friction may be found by combining the two equations shown below. For two different sections (C and B) the forces against the slat (Fc, Fb) are the sum of the force applied in the measurement direction due to the material weight (Fw) and force due to friction from sliding the material up the floor (Ff).

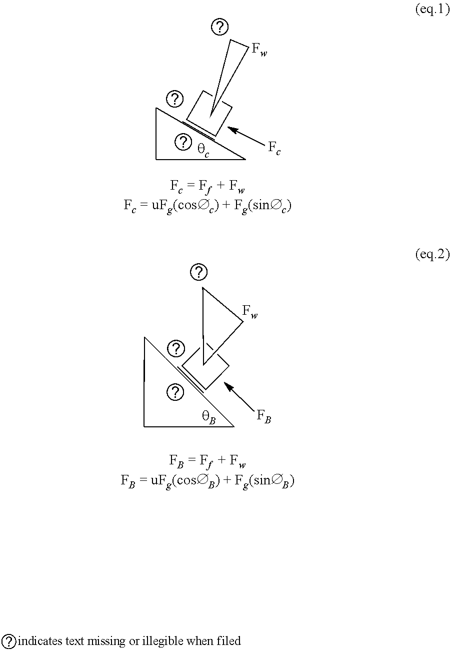

The two equations shown above contain two unknown values (Fg, and u). Combining equations 1 and 2 solves for the coefficient of friction (equation 3 shown below), which can be used to calculate Fg from either section B or C.

$${F}_{c} = {F}_{g} [ u ( cos {∅}_{c} ) + ( sin {∅}_{c} ) ] \qquad ( eq . 3 )$$

$${F}_{B} = {F}_{g} [ u ( cos {∅}_{B} ) + ( sin {∅}_{B} ) ]$$

$$\frac{{F}_{C}}{{F}_{B}} = \frac{{F}_{g} [ u ( cos {∅}_{C} ) + ( sin {∅}_{C} ) ]}{{F}_{g} [ u ( cos {∅}_{R} ) + ( sin {∅}_{B} ) ]}$$

$$[ u ( cos {∅}_{B} ) + ( sin {∅}_{B} ) ] \frac{{F}_{C}}{{F}_{B}} = u ( cos {∅}_{C} ) + ( sin {∅}_{C} )$$

$$u ( cos {∅}_{B} ) \frac{{F}_{C}}{{F}_{B}} - u ( cos {∅}_{C} ) = ( sin {∅}_{C} ) - ( sin {∅}_{B} ) \frac{{F}_{C}}{{F}_{B}}$$

$$u [ ( cos {∅}_{B} ) \frac{{F}_{C}}{{F}_{B}} - ( cos {∅}_{C} ) ] = ( sin {∅}_{C} ) - ( sin {∅}_{B} ) \frac{{F}_{C}}{{F}_{B}}$$

$$u = \frac{( sin {∅}_{C} ) - ( sin {∅}_{B} ) \frac{{F}_{C}}{{F}_{B}}}{( cos {∅}_{B} ) \frac{{F}_{C}}{{F}_{B}} - ( cos {∅}_{C} )}$$

Using the coefficient of friction and the force resulting from conveying material in section B or C, the weight of material being conveyed can be calculated. Combined with elevator speed (measured by the IMU), the mass flow of the elevator is provided.

If the friction coefficient is reasonably predictable or measured by other methods (e.g. inferred by moisture) the benefits of the auto-taring may be applied to elevators with single slopes. More than one slat assembly may be used to increase sample rate.

It should be noted that flexing and/or twisting of a slat under load can cause the measurements by an IMU mounted to the slat to produce inaccurate angle measurements. For example, the slat itself may flex or be otherwise deformed by the weight of material the slat is moving and related forces. Also, the slat may twist or move due to the flexing of the roller chain to which the slat is connected. One or more IMUs can be mounted to the frame of an elevator to generate angle data. In embodiments where flexing of a slat can occur, angles are measured by one or more IMUs mounted to the elevator frame.

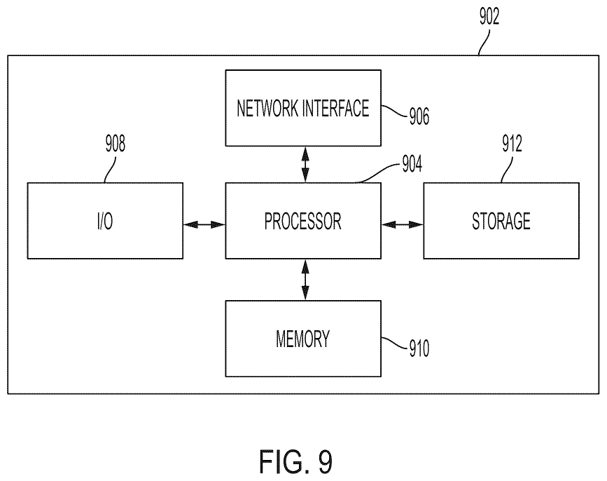

Each of the devices shown in FIG. 5, as well as other methods, devices, techniques, and algorithms described herein, can be implemented using a computer. A high-level block diagram of such a computer is illustrated in FIG. 9. Computer 902 contains a processor 904 which controls the overall operation of the computer 902 by executing computer program instructions which define such operation. The computer program instructions may be stored in a storage device 912, or other computer readable medium (e.g., magnetic disk, CD ROM, etc.), and loaded into memory 910 when execution of the computer program instructions is desired. Thus, the methods, devices, techniques, and algorithms described herein, can be defined by the computer program instructions stored in the memory 910 and/or storage 912 and controlled by the processor 904 executing the computer program instructions. For example, the computer program instructions can be implemented as computer executable code programmed by one skilled in the art to perform the methods, operation of devices, techniques, and algorithms described herein. Accordingly, by executing the computer program instructions, the processor 904 executes an algorithm defined by the methods, devices, techniques, and algorithms described herein. The computer 902 also includes one or more network interfaces 906 for communicating with other devices via a network. The computer 902 also includes input/output devices 908 that enable user interaction with the computer 902 (e.g., display, keyboard, mouse, speakers, buttons, etc.) One skilled in the art will recognize that an implementation of an actual computer could contain other components as well, and that FIG. 9 is a high-level representation of some of the components of such a computer for illustrative purposes.

The foregoing Detailed Description is to be understood as being in every respect illustrative and exemplary, but not restrictive, and the scope of the inventive concept disclosed herein is not to be determined from the Detailed Description, but rather from the claims as interpreted according to the full breadth permitted by the patent laws. It is to be understood that the embodiments shown and described herein are only illustrative of the principles of the inventive concept and that various modifications may be implemented by those skilled in the art without departing from the scope and spirit of the inventive concept. Those skilled in the art could implement various other feature combinations without departing from the scope and spirit of the inventive concept.

1. A method for determining a mass flow of harvested material moving through a material elevator, the method comprising:
receiving load data from a force sensor mounted to a slat of the material elevator;
receiving data from an inertial measurement unit (IMU) pertaining to an angle of the slat; and
determining a mass flow of material conveyed by the material elevator based on the load data and the data from the inertial measurement unit.

2. The method of claim 1, wherein the IMU is located on the slat.

3. The method of claim 1, wherein the IMU is located on a frame of the material elevator.

4. The method of claim 1, wherein a first IMU is located on the slat and a second IMU is mounted to a frame of the material elevator.

5. The method of claim 4, wherein the first IMU measures movement of the slat and the second IMU measures an angle between a direction of the movement of the slat and horizontal.

6. The method of claim 1, further comprising:
determining a coefficient of friction based on the load data and the data from the IMU;
determining a force associated with the slat as it is conveying material;
determining a weight of material conveyed by the slat based on the coefficient of friction and the force associated with the slat; and
determining a speed of the material elevator based on the data from the IMU.

7. The method of claim 6, wherein the determining a coefficient of friction is based on the load data measured at a plurality of points of the slat travel.

8. The method of claim 1, wherein a change in amplitude of a signal from the force sensor of an unloaded slat on an unloaded side of the material elevator is used to correct a signal from the force sensor of the slat measured on a loaded side of the material elevator.

9. An apparatus comprising:
a force sensor mounted to a slat of a material elevator and configured to generate load data;
an inertial measurement unit (IMU) configured to generate IMU data; and
a slat module mounted to a slat and configured to perform operations comprising:
receiving load data from the force sensor mounted to a slat of the material elevator;
receiving data from the IMU pertaining to an angle of the slat; and
determining a mass flow of material conveyed by the material elevator based on the load data and the data from the inertial measurement unit.

10. The apparatus of claim 9, wherein the IMU is located on the slat.

11. The apparatus of claim 9, wherein the IMU is located on a frame of the material elevator.

12. The apparatus of claim 9, wherein a first IMU is located on the slat and a second IMU is mounted to a frame of the material elevator.

13. The apparatus of claim 12, wherein the first IMU measures movement of the slat and the second IM measures an angle between a direction of the movement of the slat and horizontal.

14. The apparatus of claim 9, the operations further comprising:
determining a coefficient of friction based on the load data and the data from the IMU;
determining a force associated with the slat as it is conveying material;
determining a weight of material conveyed by the slat based on the coefficient of friction and the force associated with the slat;
determining a speed of the material elevator based on the data from the IMU; and
determining the mass flow of material conveyed by the material elevator based on the weight of material conveyed and the speed of the material elevator.

15. A computer readable medium storing computer program instructions for determining a mass flow of harvested material moving through a material elevator, which, when executed on a processor, cause the processor to perform operations comprising:
receiving load data from a force sensor mounted to a slat of the material elevator;
receiving data from an inertial measurement unit (IMU) pertaining to an angle of the slat; and
determining a mass flow of material conveyed by the material elevator based on the load data and the data from the inertial measurement unit.

16. The computer readable medium of claim 15, wherein the IMU is located on the slat.

17. The computer readable medium of claim 15, wherein the IM is located on a frame of the material elevator.

18. The computer readable medium of claim 15, wherein a first IMU is located on the slat and a second IMU is mounted to a frame of the material elevator.

19. The computer readable medium of claim 18, wherein the first IMU measures movement of the slat and the second IMU measures an angle between a direction of the movement of the slat and horizontal.

20. The computer readable medium of claim 15, the operations further comprising:
determining a coefficient of friction based on the load data and the data from the IMU;
determining a force associated with the slat as it is conveying material;
determining a weight of material conveyed by the slat based on the coefficient of friction and the force associated with the slat; and
determining a speed of the material elevator based on the data from the IMU.
